(19) United States
(12) Patent Application Publication
(10) Pub. No.: US 2013/0311742 A1
(43) Pub. Date: Nov. 21, 2013

(54) IMAGE MANAGEMENT METHOD, MOBILE TERMINAL AND COMPUTER STORAGE MEDIUM

(71) Applicant: Tencent Technology (shenzhen) Company Limited, Shenzhen (CN)

(72) Inventors: Xun Ding, Shenzhen (CN); Bin Ma, Shenzhen (CN); Xin Wan, Shenzhen (CN)

(73) Assignee: Tencent Technology (Shenzhen) Company Limited, Shenzhen (CN)

(21) Appl. No.: 13/950,690

(22) Filed: Jul. 25, 2013

Related U.S. Application Data
(63) Continuation of application No. PCT/CN2011/083976, filed on Dec. 14, 2011.

(30) Foreign Application Priority Data
Jan. 26, 2011 (CN) CN 201110028536.0

(51) Int. Cl. G06F 12/02

(52) U.S. Cl. CPC G06F 12/023
USPC 711/170

(57) ABSTRACT

An image management method is disclosed. The method includes: receiving images; caching the received images to a memory space; determining if free memory size is less than the threshold, if yes, releasing the memory space. According to the method, mobile terminal and computer storage medium, the free memory size is determined if less than the threshold in the process of obtaining images, if yes, the memory space is released. In this way, the memory could be saved so as to provide enough space for image processing, which reduces the incidence of errors and improves the efficiency during manipulating the image.

### RELATED APPLICATIONS

This application is a continuation of International Application No. PCT/CN2011/083976, filed Dec. 14, 2011, which claims priority to Chinese Application No. CN 201110028536.0, filed Jan. 26, 2011, entitled IMAGE MANAGEMENT METHOD, MOBILE TERMINAL AND COMPUTER STORAGE MEDIUM, both of which are hereby being fully incorporated by reference.

### FIELD OF THE INVENTION

The present invention relates to the computer technology, and more particularly, to an image management method, mobile terminal and computer storage medium.

### BACKGROUND OF THE INVENTION

With the development of mobile internet, the mobile internet has been accepted by more and more internet users, and becomes one of essential ways to access internet for most users. Mobile internet has been widely used not only in user's daily leisure and entertainment, but also in the work.

The internet-connected device, mobile terminals such as mobile phone and tablet computer are used frequently by mobile internet users. Users can send or receive images through mobile phone and tablet computer. However, due to the little memory space used for image processing in these mobile terminals, errors often occur when the user manipulates the image, making the manipulation inefficient.

### SUMMARY OF THE INVENTION

Therefore, there is a need to provide an image management method which can save memory space.

Furthermore, there is also a need to provide a mobile terminal which can save memory space.

Still further, there is also a need to provide a computer storage medium which can save memory space.

An image management method, includes:
receiving images;
caching the received images to a memory space; and
determining if free memory size of the memory space is less than the threshold, if yes, then releasing the memory space.

A mobile terminal, includes:
a receiving module, configured to receive images;
a memory space, configured to cache the received images; and
a memory control module, configured to determine if free memory size of the memory space is less than the threshold, if yes, then release the memory space.

A computer storage medium with computer-executable instructions stored to control a computer to execute an image management method, the method includes:
receiving images;
caching the received images to a memory space; and
determining if free memory size of the memory space is less than the threshold, if yes, then releasing the memory space.

According to the method, mobile terminal and computer storage medium, the free memory size of the memory space is determined if less than the threshold in the process of getting images, if yes, the memory space is released. In this way, the memory space could be saved so as to provide enough space for the image processing, which reduces the incidence of errors and improves the efficiency of manipulating the image.

### BRIEF DESCRIPTION OF THE DRAWINGS

FIG. 1 is a flowchart of image management method in Embodiment 1;

FIG. 2 is a flowchart of image management method in Embodiment 2;

FIG. 3 is a flowchart of image management method in Embodiment 3;

FIG. 4 is a schematic diagram of mobile terminal in Embodiment 4;

FIG. 5 is a schematic diagram of mobile terminal in Embodiment 5;

FIG. 6 is a schematic diagram of query module in Embodiment 6.

### DETAILED DESCRIPTION OF THE PREFERRED EMBODIMENTS

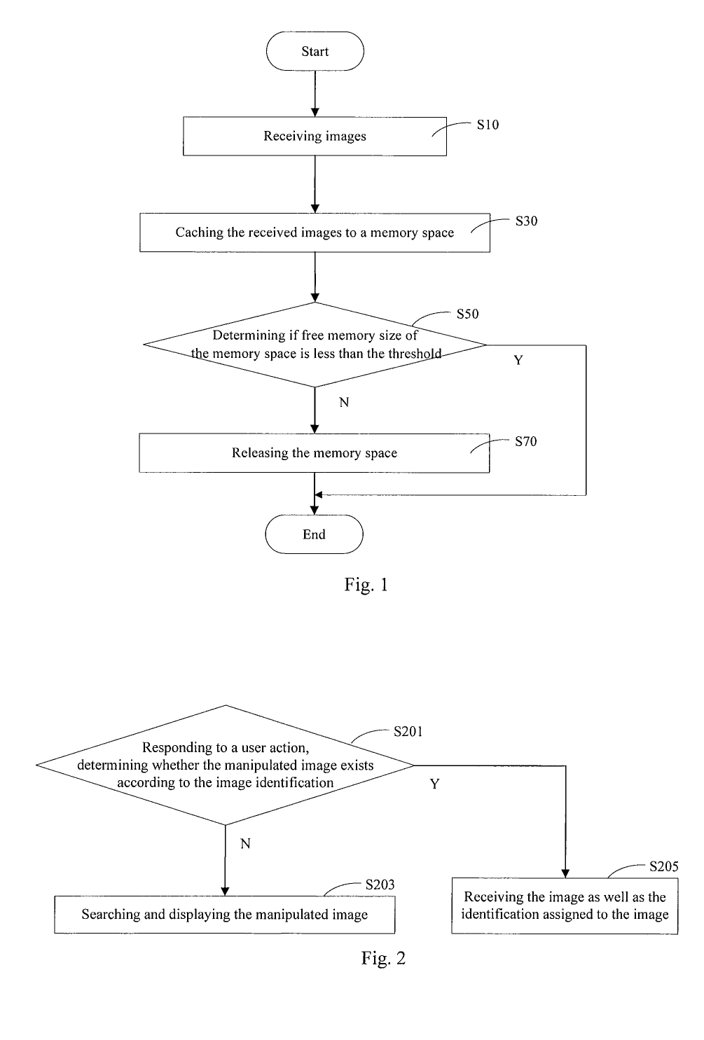

FIG. 1 shows the image management method in Embodiment 1, the method includes the following steps:

Step S10, receiving images. In this embodiment, during the process of image sending and receiving manipulation, receive the image sent from other users, and obtain the identification assigned to the received image. The identification can give the image a unique identifier, which could be assigned uniformly by the backend server. For example, the image identification could be unique information such as identification code and identification name. For instance, when other users click “Send” button to send out the image which could be obtained through photographing or selected from locally stored images, receive the image as well as the identification assigned to the image.

Step S30, caching the received images to a memory space. In this embodiment, take the image identification as the index and cache the received images to a memory space. Furthermore, identification code could also be taken as the key value or name of the images cached to memory space. In Step S30, receive the image information, including encoding/decoding format, size, storage space, compression ratio and generated time of the image. Then cache the received images as well as their information to the memory space.

Step S50, determining if free memory size of the memory space is less than the threshold, if yes, go to Step S70. In this embodiment, query whether the situation that free space of memory is not enough occurs, i.e., detect the usage of memory space. When free memory size of the memory space is less than the set threshold, consider that the situation of insufficient memory occurs.

In an embodiment, the specific procedure of Step S50 is: detect the memory space allocated for image processing and the overall memory usage, when free memory size of the memory space is less than the threshold, consider that the situation of insufficient memory occurs. In another embodiment, the specific procedure of Step S50 is: detect the trigger event of image processing manipulation, such as displaying, saving, editing, deleting, optimizing and sending/receiving of the image; obtain the memory space allocated for image processing and the overall memory usage when the event of image processing manipulation happens; when free memory size of the memory space is less than the set threshold, consider that the situation of insufficient memory occurs.

Step S70, releasing the memory space. In this embodiment, when memory doesn't have enough space, there is a need to release the image cached to memory and extend the free memory.

In a preferred embodiment, when the memory doesn't have enough space, release the memory space occupied by the image with the least access. Specifically, the procedure of releasing the memory space is: calculate the weight of each image cached to the memory space according to its access status and size; compare all the images' weights to obtain an image with the minimum weight; delete an image with the minimum weight.

The access status of the image includes number N of user's view, time T for user's last view and so on. Assign weight W for the image saved in memory space, comprising the following parts: number N of user's view, time T for user's last view, image size S. Every time caching the image to memory space or the manipulation of viewing image triggered by user, one or a few value of the above parts comprising the weight would be changed. The weight W is calculated by the following formula:

W=a*N−b*(t−T)+c*S

Wherein, a, b and c are constants obtained based on experience; t is the current time.

Compare all the images' weights in the memory space, and image with the minimum weight is the image accessed the least.

In another embodiment of the invention, after caching the received images to the memory space, the method further includes: saving the image in memory space to local disk. In this embodiment, the image is saved to local disk at regular time in order to release the memory space. Furthermore, the user could also save the image to local disk manually when viewing the image.

In other embodiments of the invention, after receiving the images, the method includes: returning the image identification. In this embodiment, return the identification assigned to the image to user sending the image, and notify the user whether the image has been sent out successfully.

FIG. 2 shows the flow of image management method in Embodiment 1. When the user views the image, before receiving images, the method further includes the following steps:

In Step S201, respond to a user action, determining whether the manipulated image exists according to the image identification, if yes, go to Step S203, if not, go to Step S205. In this embodiment, the user triggers the manipulation of viewing image. At this moment, firstly, determine whether the manipulated image exists, if yes, there is no need to initiate a request to receive the image through internet, only need to search and display the manipulated image, if not, then initiate a request to receive the image through internet.

In Step S203, search and display the manipulated image. In Step S205, receive the image as well as the identification assigned to the image.

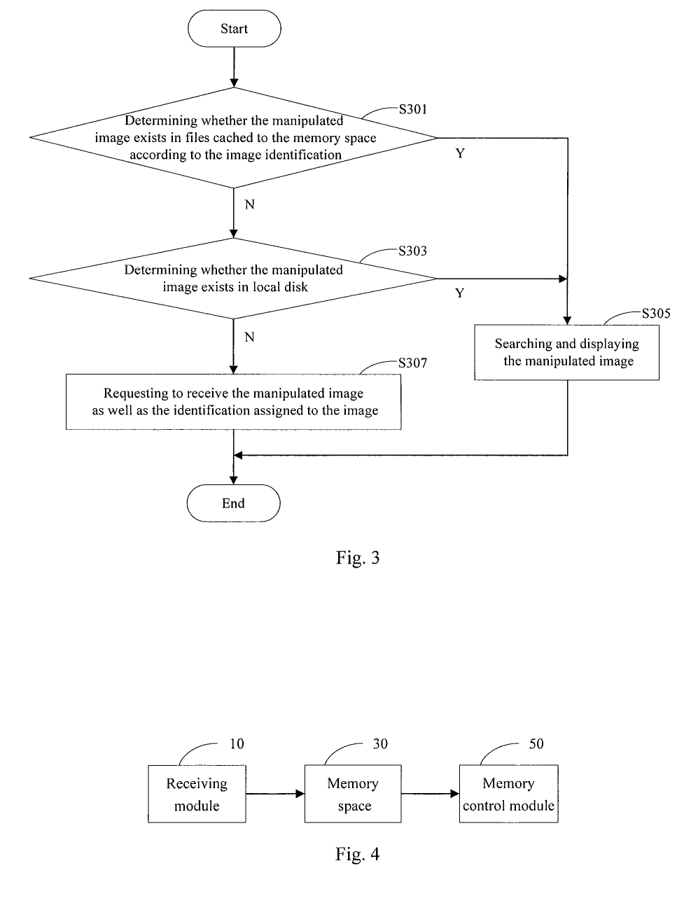

In Embodiment 3, FIG. 3 shows the flow of image management method in a specific embodiment. The method includes the following steps:

In Step S301, determine whether the manipulated image exists in files cached to the memory space according to the image identification, if yes, go to Step S305, if not, go to Step S303. In this embodiment, the files cached to memory space are saved by taking the image identification as the index. Determine whether there is a image with the same identification exists in memory space according to the image identification, if yes, search the manipulated image in memory space, refresh and display the image, if not, then query whether the manipulated image exists in local disk.

In Step S303, determine whether the manipulated image exists in local disk, if yes, go to Step S305, if not, go to Step S307. In this embodiment, determine whether the manipulated image exists in local files according to the image identification, if yes, search image with the same identification in local disk, refresh and display the image, if not, then request to receive the manipulated image as well as the identification assigned to the image.

In Step S305, search and display the manipulated image.

In Step S307, request to receive the manipulated image as well as the identification assigned to the image.

Furthermore, in Embodiment 4, it is also necessary to provide a mobile terminal. As shown in FIG. 4, the mobile terminal includes a receiving module 10, a memory space 30 and a memory control module 50.

Receiving module 10 is configured to receive images. In this embodiment, receiving module 10 receives the identification assigned to the received image. The identification can give the image a unique identifier, for example, the image identification could be unique information such as identification code and identification name. When other users click “Send” button to send out the image which could be obtained through photographing or selected from locally stored images, the server receives the image and assigns corresponding identification for the image.

The memory space 30 is configured to cache the received images. In this embodiment, the memory space 30 takes the image identification as the index and cache the received image. Furthermore, the identification code could also be taken as the key value or name of the image cached to memory space. When the image is saved, the image information is saved as well, which includes encoding/decoding format, size, storage space, compression ratio and generated time of the image. Then the received image as well as its information is cached to the memory space 30.

The memory control module 50 is configured to determine if free memory size of the memory space is less than the threshold, if yes, releases the memory space. The memory control module 50 queries whether the situation of insufficient memory occurs, i.e., detects the usage of memory space. The situation of insufficient memory is considered to occur when the unused memory space 30 is less than the set threshold.

In an embodiment, the memory control module 50 detects the memory space allocated for image processing and the overall memory usage. When the free memory size is less than the threshold, the situation of insufficient memory is considered to occur. Besides, in another embodiment, the memory control module 50 is configured to detect the trigger event of image processing manipulation, such as displaying, saving, editing, deleting, optimizing and sending/receiving of the image; obtain the memory space allocated for image processing and the overall memory usage when the event of image processing manipulation happens; when the free memory size is less than the set threshold, consider that the situation of insufficient memory occurs.

When the memory doesn't have enough space, the memory control module 50 releases the memory space occupied by the image with the least access. Specifically, the memory control module 50 calculates the weight of every image cached to the memory space 30 according to its access status and size; compares all the images' weights to obtain an image with the minimum weight; deletes an image with the minimum weight. The access status of the image includes number N of user's view, time T for user's last view, etc.

The memory control module 50 assigns weight W for the image saved in the memory space 30, comprising the following parts: number N of user's view, time T for user's last view, image size S. Every time the image is cached to memory space or the manipulation of viewing image is triggered by user, one or a few value of the above parts comprising the weight would be changed. The weight W is calculated by the following formula:

W=a*N−b*(t−T)+c*S

Wherein, a, b and c are constants obtained based on experience; t is the current time.

Compare all the images' weights in the memory space 30, and image with the minimum weight is the image accessed the least.

In another embodiment of the invention, the mobile terminal 30 further includes a local storage module configured to save the image in memory space to local disk. In this embodiment, the local storage module saves the image in the memory space 30 to local disk at regular time, in order to release the image cached to the memory space 30. Furthermore, the user could also save the image to local disk manually when viewing the image.

In other embodiments of the invention, the server returns the image identification to user sending the image. In this embodiment, the server returns the identification assigned to the image to user sending the image, and notify the user whether the image has been sent out successfully.

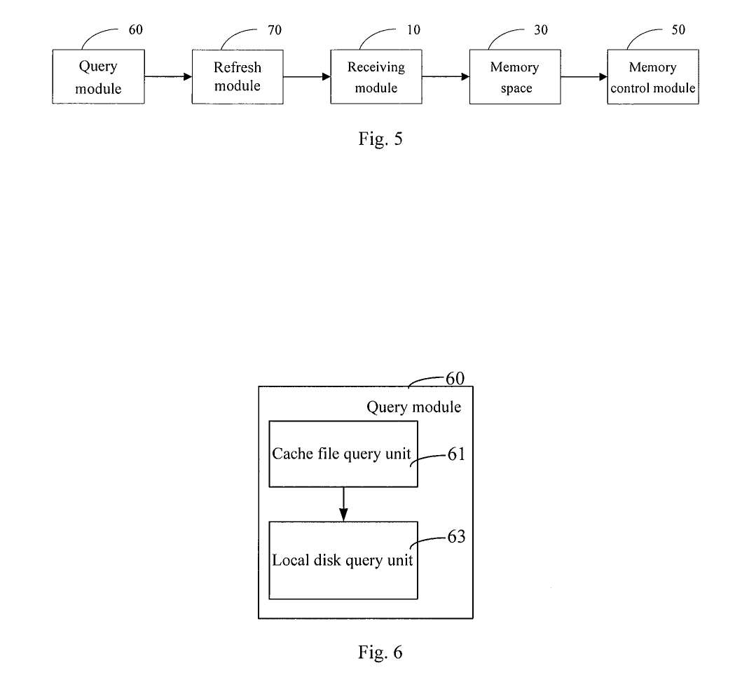

FIG. 5 shows the mobile terminal in Embodiment 5, which includes a query module 60 and a refresh module 70.

The query module 60 is configured to respond to a user action, determine whether the manipulated image exists according to the image identification, if yes, notify the refresh module 70, if not, notify the receiving module 10. In this embodiment, the user triggers the manipulation of viewing image. The query module 60 firstly responds to the user action, determines whether the manipulated image exists according to the image identification, if yes, there is no need to initiate a request to receive the image through internet, the refresh module 70 only needs to search and display the manipulated image, if not, the receiving module 10 only needs to initiate a request to receive the image through internet.

The refresh module 70 is configured to search and display the manipulated image.

The receiving module 10 is also configured to receive the identification assigned to the received image.

FIG. 6 shows the query module in Embodiment 6, which includes a cache file query unit 61 and a local disk query unit 63.

The cache file query unit 61 is configured to determine whether the manipulated image exists in files cached to the memory space according to the image identification, if yes, notify the refresh module, if not, notify the local disk query unit 63. In this embodiment, the cache file query unit 61 determines whether there is a image with the same identification existing in memory space according to the image identification, if yes, the refresh module 70 searches the manipulated image in the memory space 30, refreshes and displays the image, if not, then the local disk query unit 63 queries whether the manipulated image exists in local disk.

The local disk query unit 63 is configured to determine whether the manipulated image exists in local disk according to the image identification, if yes, notify the refresh module 70 to search and display the manipulated image, if not, notify the receiving module 10 to request to receive the manipulated image. In this embodiment, the local disk query unit 63 determines whether the manipulated image exists in local disk according to the image identification, if yes, the refresh module 70 searches image with the same identification in local disk, refreshes and displays the image, if not, requests to receive the manipulated image.

In the above image management method and mobile terminal, each image processed by the server would be assigned to a unique image identification by the server. When saving the received image to memory space, mobile terminal takes the identification as the key value or name of the image. Server searches the image needed to view in memory space through its identification, if there is not the image in the memory space, then searches the image in local disk according to the identification, if the server finds the same image in memory space, then it is the image that user needs to view.

When sending the image, the mobile terminal will receive image's identification code distributed by the server and get the notice about whether the image has been sent out successfully.

The invention also provides a computer storage medium with computer-executable instructions stored to control a computer to execute the above image management method, the specific steps of the image management method have been described in the above.

The image management method and system could be applied to mobile terminals, such as smart mobile phone, tablet computer and other mobile terminals with little memory space. Using the image management method and system, the client of mobile terminal could receive and display images.

According to the method, mobile terminal and computer storage medium, the free memory size is determined if less than the threshold in the process of getting image, if yes, the memory space is released. In this way, the memory space could be saved so as to provide enough for the image processing, which reduces the incidence of errors and improves the efficiency during manipulating the image.

It should be emphasized that the above-described embodiments of the present invention, are merely possible examples of implementations. Many variations and modifications may be made to the above-described embodiments of the invention without departing substantially from the spirit and principles of the invention. All such modifications and variations are intended to be included herein within the scope of this disclosure and the present invention and protected by the following claims.

What is claimed is:

1. A method of managing the free memory space of a memory by a memory controller in a mobile terminal, wherein a plurality of images are stored in the memory, the method comprising:
in response to the memory controller receiving an event, determining by the memory controller if the size of the free memory space of the memory is less than a threshold; and
on determining that the size of the free memory space is less than the threshold, releasing memory space previously allocated in the memory, wherein releasing previously allocated memory space includes deleting a one of the plurality of images wherein the one of the plurality of images is selected based on comparing a respective weight associated with each of the plurality of images.

2. The method of claim 1 further comprises in response to receiving a request for an image determining if the requested image corresponds to a one of the plurality of images.

3. The method of claim 2, wherein in response to determining that the requested image corresponds to a one of the plurality of images, displaying the one of the plurality of images at the mobile terminal.

4. The method of claim 3 wherein in response to determining that the requested image does not correspond to a one of the plurality of images receiving the requested image via a communication network.

5. The method of claim 1 further comprises determining the threshold based on memory space allocated for image processing and overall memory usage.

6. The method of claim 1 wherein the event corresponds to either a request for processing a one of the plurality of images or a request for an image.

7. The method of claim 1 further comprises calculating the respective weight associated with each of the plurality of images based on a respective access status and a respective size of each of the plurality of image and wherein the one of the plurality of images selected has the lowest respective weight.

8. A mobile terminal comprising:
a memory adapted to store a plurality of images;
a receiver module adapted to communicate via a network; and
a memory controller configured to compare the size of the free memory space of the memory with a threshold in response to receiving an event and based on determining that the free memory space is less than the threshold selecting a one of the plurality of images based on comparing a respective weight associated with each of the plurality of images and deleting the selected one of the plurality of images.

9. The mobile terminal of claim 8 further comprises a query unit configured to respond to a user request for an image and determine based on an image identifier associated with the image if the image corresponds to a one of the plurality of images in the memory and based on determining that the image exists in memory displaying the image at the mobile terminal.

10. The memory controller of claim 10 further configured to cause the receiving unit to receive the requested image in response to the query unit determining that the requested image does not correspond to a one of the plurality of images in the memory.

11. The memory controller of claim 8 further configured to determine the threshold based on memory space allocated for image processing and overall memory usage.

12. The mobile terminal of claim 8 wherein the event corresponds to either a request for processing a one of the plurality of images or a request for an image.

13. The memory controller of claim 8, wherein the memory controller is further configured to calculate the respective weight associated with each of the plurality of images based on a respective access status and a respective size of each of the plurality of images and wherein the one of the plurality of images selected has the lowest respective weight.

14. A non-transitory computer readable media including program instructions which when executed by a memory controller of a mobile terminal, wherein a plurality of images are stored in a memory, cause the memory controller to perform a method comprising:
in response to the memory controller receiving an event, determining by the memory controller if the size of the free memory space of the memory is less than a threshold; and
on determining that the size of the free memory space is less than the threshold, releasing memory space previously allocated in the memory wherein releasing previously allocated memory space includes deleting a one of the plurality of images wherein the one of the plurality of images is selected based on comparing a respective weight associated with each of the plurality of images.

15. The method of claim 14 further comprises in response to receiving a request for an image determining if the requested image corresponds to a one of the plurality of images.

16. The method of claim 15, wherein in response to determining that the requested image corresponds to a one of the plurality of images, displaying the one of the plurality of images at the mobile terminal.

17. The method of claim 16 wherein in response to determining that the requested image does not correspond to a one of the plurality of images receiving the requested image via a communication network.

18. The method of claim 14 further comprises determining the threshold based on memory space allocated for image processing and overall memory usage.

19. The method of claim 14 wherein the event corresponds to either a request for processing a one of the plurality of images or a request for an image.

20. The method of claim 14 further comprises calculating the respective weight associated with each of the plurality of images based on a respective access status and a respective size of each of the plurality of image and wherein the one of the plurality of images selected has the lowest respective weight.
